(19) United States
(12) Patent Application Publication
(10) Pub. No.: US 2014/0217733 A1
(43) Pub. Date: Aug. 7, 2014

(54) Waves Weight Based Energy Power Generation System

(71) Applicant: Stephan Vincent Kroecker, Titusville, FL (US)

(72) Inventor: Stephan Vincent Kroecker, Titusville, FL (US)

(73) Assignee: Stephan Vincent Kroecker, Titusville, FL (US)

(21) Appl. No.: 13/453,121

(22) Filed: Apr. 23, 2012

(51) Int. Cl. F03B 13/14; F03B 13/10

(52) U.S. Cl. CPC F03B 13/14; F03B 13/10
USPC 290/53

(57) ABSTRACT

This is a system of kinetic power generating stations including a plurality of opposing units needed to generate electrical power from the constant motion of waves. Utilizing mixed gas inside the flexible membrane component of the piston to maximize the effects of the changing weight of the passing waves is being employed to assure continuity and uninterrupted movement of the piston assemblies. These “lollipop” pistons are required for electricity generation from waves.

The entire system is designed with limited maintenance requirements and allowing for ease of accessibility, either while submerged or while being surfaced for review and repair.

Connected as a field of generators offshore from a shore side inter-connect these units will be virtually out-of-site, out-of-mind, preserving the visual environment of a pristine beachside location. The units can be programmed to provide an underwater light show while serving as a beacon to passing vessels.

### BACKGROUND OF THE INVENTION

The present invention relates to generating renewable and clean energy from the kinetic energies formed but not harnessed, from constantly moving waves. The energy created by a wave's weight and speed (momentum) can be accumulated and then harnessed into clean electrical energy.

It is recognized that there are ancillary purposes for this invention and not limited to power generation alone. The invention contemplates the reduction and reliance on fossil fuels; and the energy independence of harnessing a kinetic fuel source with endless resources; and, with a no cost aspect.

The present invention contemplates one or more underwater generating stations placed in an average depth of one hundred to one hundred fifty feet; while still being readily accessible from shore. This system will operate on a 24 hour continuous basis, while leaving an unobstructed visual representation of our sea shores.

The invention would provide numbers of units working in series, underwater and delivering green energies to a seaside point of connection, to the local public grid. Although, submerged and silent, the units can be utilized as a ‘attraction’ for promotion and understanding of the technology by integrating the ancillary lighting system, which can be programmed to offer differing visual presentations.

### BRIEF SUMMARY OF THE INVENTION

A system by which kinetic energies are harvested by utilization of wave weight to generate and deliver power in the form of electricity measured by standard units [i.e. kWh kilowatt hours; mWh megawatt hours] that upon generation can be; stored in batteries or capacitor type energy storage devices; linked directly to the public grid for immediate use and resale.

Supplementary to the power generation aspects of the invention, are the direct reduction of fossil fuel dependence; the endless supply of waves sufficient in height; frequency; duration and depth to continuously provide the mechanism for operation; the provision of jobs in both the technical as well as the undersea realms.

### BRIEF DESCRIPTIONS OF THE DRAWINGS

FIG. 1 illustrates one exemplary form of a station's structure having a side view in accordance with the present invention;

FIG. 2 illustrates the end and top views of the invention in FIG. 1;

FIG. 3 is the embodiment of dual units connected side by side from the end view of the invention used in FIG. 1;

FIG. 4 illustrates through FIGS. 4A; 4B and 4C the component parts of the inventions capabilities in vertical movement of up and down of the invention in FIG. 1;

FIG. 5 illustrates through 5A; 5B; 5C; 5D and 5E the components specific to the base section and vertical shaft of the invention used in FIG. 1;

FIG. 6 illustrates through FIGS. 6A and 6B, the base structure in both side and top view of the invention shown in FIG. 1;

FIG. 7 illustrates through FIGS. 7A; 7B and 7C the primary component required for the submersion and surfacing of the invention in FIG. 1;

FIG. 8 illustrates form a top view, the application of components illustrated in FIG. 7 when the invention is configured as four units for convenience, by the invention as shown in FIG. 1;

FIG. 9 illustrates the common configurations to the invention when placed side by side and incorporating a vertical and lateral support structure as shown in FIG. 1;

FIG. 10 illustrates from the top view, the common configuration of the invention when utilized and applied as four units for convenience as shown in FIG. 1;

FIG. 11 illustrates the components of the invention making up the support structure of the invention as shown in FIG. 1;

FIG. 12 illustrates through FIGS. 12A and 12B from the top view of the units placed in series with and without the utilization of the submersible components of the invention in FIG. 1;

FIG. 13 illustrates the side view of the unit configured for the utilization of a secondary component which is mechanical rather than hydraulic in the application of the invention in FIG. 1;

FIG. 14 illustrates the side views of the components specific to the lighting, to appraise the promotion, knowledge and awareness of the invention in FIG. 1;

### DETAIL DESCRIPTION OF THE INVENTION

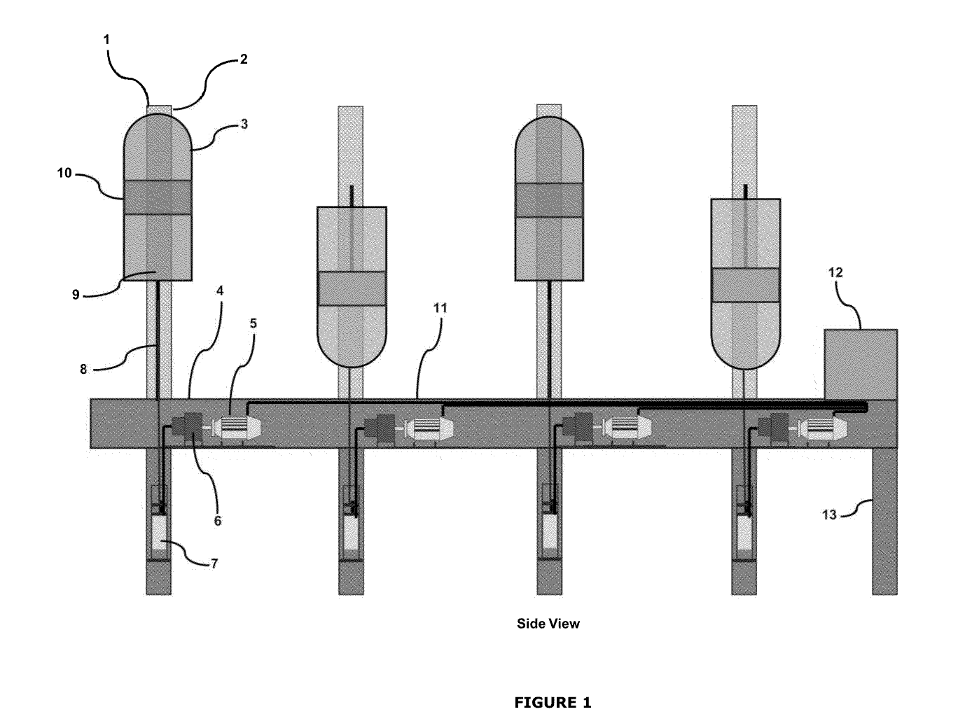

Turning now to FIG. 1, there is shown the side view of an embodiment of single unit that may be utilized to form a larger set of units providing requisite amount of power generation measured in Kilowatt or Megawatt hours used to implement the functions described above. In the example of FIG. 1, we view the side view of two complete units mated together to form a dual unit section with the capabilities of 600 kW, 1, Noticing the single vertical guide rail; 2, a side view of the upper most level of actuator movement; 3, the side view of the actuator lollipop piston; 4, the side view of the composite base unit; 5, the generator from the side view; 6, shows the hydraulic motor; Turning now to 7. illustrates the hydraulic pump and reservoir; 8, indicates the drive piston shaft in relation to the hydraulic pump and reservoir; 9, shows the deflated end of the actuator lollipop membrane; 10, shows the side view of the reinforced section of the lollipop piston; 11, depicts the electric wiring utilized to deliver the generated power to the control, distribution and stabilizer component; 12, the side view of the control unit watertight cover; and, 13, is the side view of the additional supporting leg utilized to stabilize the control unit.

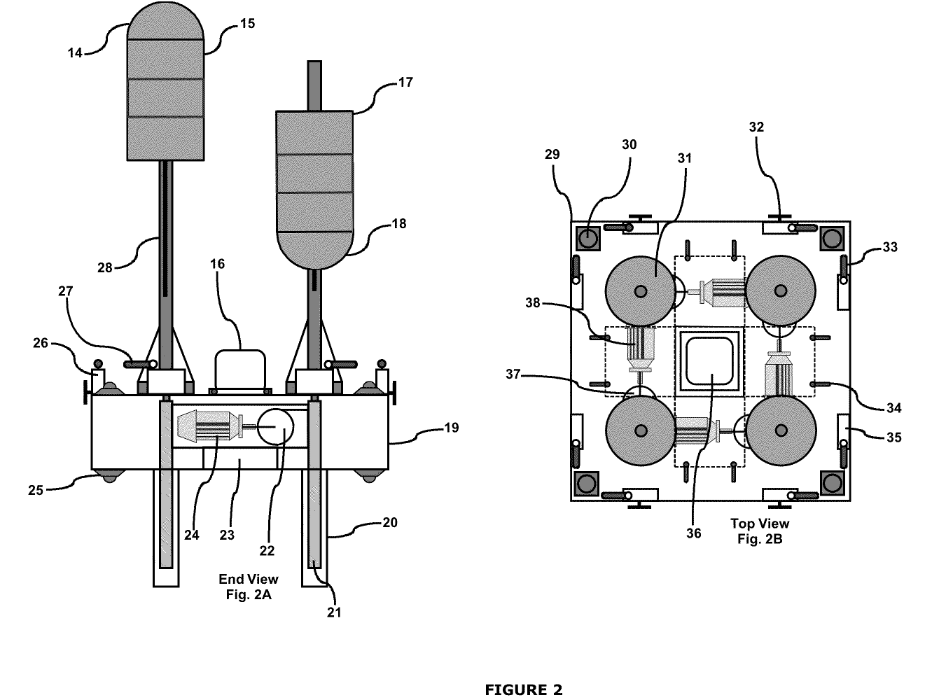

Turning now to FIG. 2, beginning with FIG. 2A; 14, illustrates the end view of the lollipop piston membrane expanded towards the surface; 15, shows the actuator lollipop piston in its upper most allowable position; 16 the end view of the controller unit watertight cover; 17, the end view of the deflated lollipop piston membrane on the downward stroke; 18, the end view of the lollipop piston membrane during the downward stroke; 19, the end view of the single unit base ; 20, the end view of the piston raceway; 21, the end view of the maximum piston shaft travel; 22, the end view of the hydraulic motor; and 23, shows a solids ballast compartment from the end view. 24, illustrates a single generator in this unit configuration; 25, shows one of keel one-way hydraulic vales for liquid ballast discharge; 26, shows the end view of the exaggerated dog lock mechanism for ease of underwater access by diver; 27, depicts the side view of the dog handle; 28, shows the vertical travel limiter; Turning now to FIG. 2B, 29, illustrates the top view of a standard single unit; 30, shows the top view of the topside one-way hydraulic for liquid ballast; 31, depicts the top view of the lollipop piston; 32, shows the top view of the connector plate; 33, shows the top view of the exaggerated dog handle; 34, depicts the smaller exaggerated dog handle accessing the unit for maintenance purposes; 35, the top view of the dog locking mechanism; 36, is the top view of the control unit watertight cover; 37, the partial top view of the hydraulic motor; and, 38, the top view of a generator.

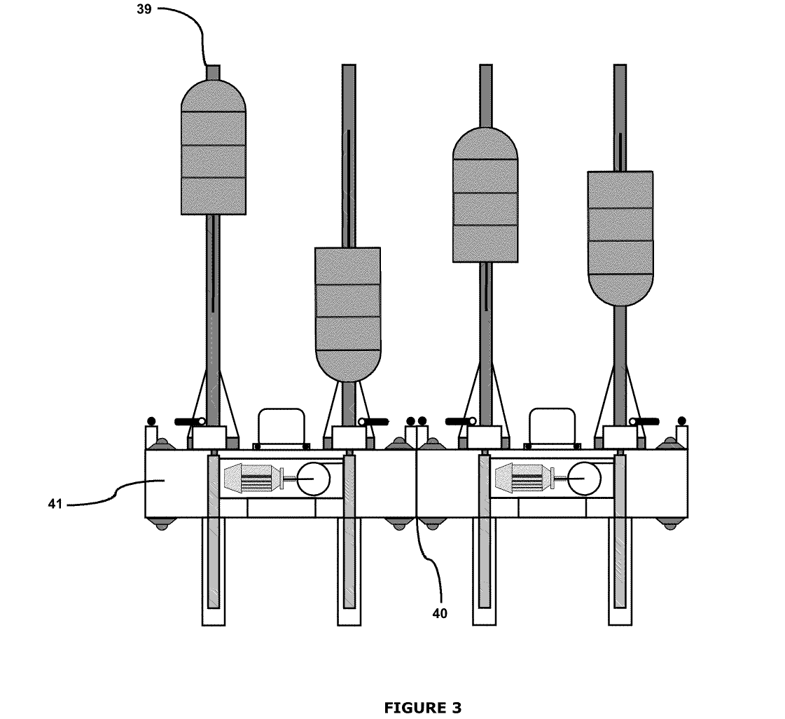

Turning now to FIG. 3, there is shown a side view of two units connected together. Considering now 39, the side view of these two units; 40, the side view of the point of connection; and, 41, the base component of all units which is environmentally neutral utilizing coatings and or materials that correspond and provide for the neutrality issue;

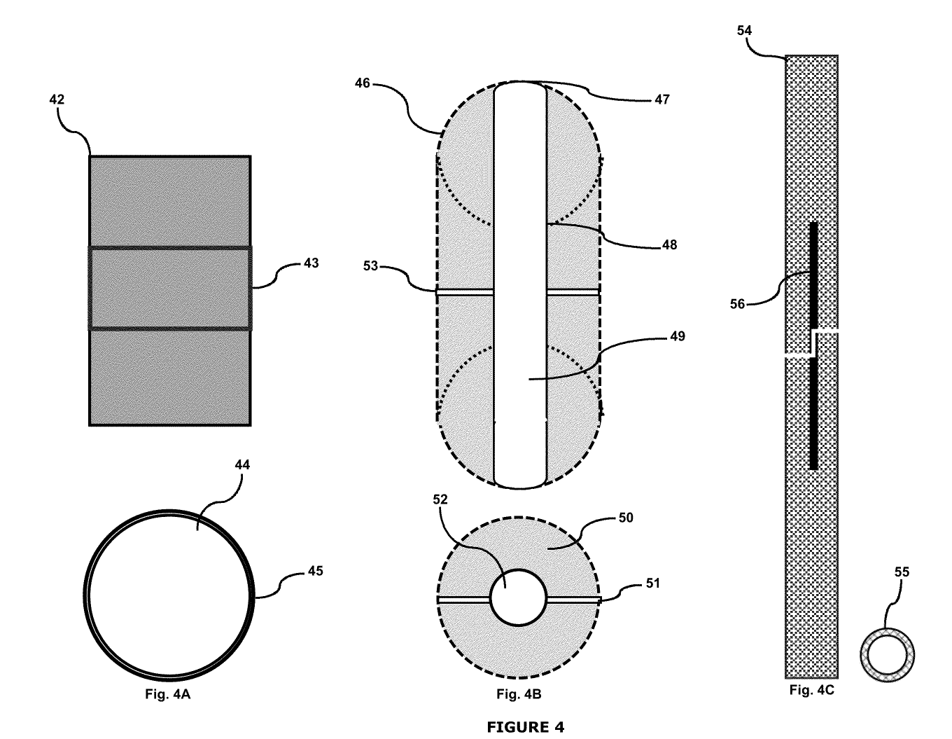

Referring now to FIG. 4, illustrates the piston and travel shaft components In FIG. 4A, 42, depicts the side view of the piston bladder housing; 43, shows the median reinforcing ring of the piston bladder housing; 44, is the top view of the piston bladder housing; and, 45, depicts the top view of the circular piston bladder housing. Referring now FIG. 4B, 46, in a side view of the piston bladder; 47, the pathway allowing unimpeded vertical travel of the piston bladder vertically on the piston guide shaft; 48, shows the side view of the piston bladders expandable upper and lower membrane section which deploys as a direct cause of the changing of the wave weight being exerted; 49, shows the bladder pathway clearly traversing the entire length of the bladder mechanism; 50, depicts the top view of the bladder mechanism; 51, shows the top view of the of the vertical travel governor bar clearly depicting this pathway transversing the bladder mechanism through the width of the bladder ; 52, illustrates the top view of the vertical shaft passageway; 53, shows the side view of the vertical governor bar; Looking now to FIG. 4C, 54, shows the side view of the vertical piston shaft; 55, illustrates the top view of the vertical piston shaft; and, 56, depicts the limiter slot for the vertical travel of the piston mechanism.

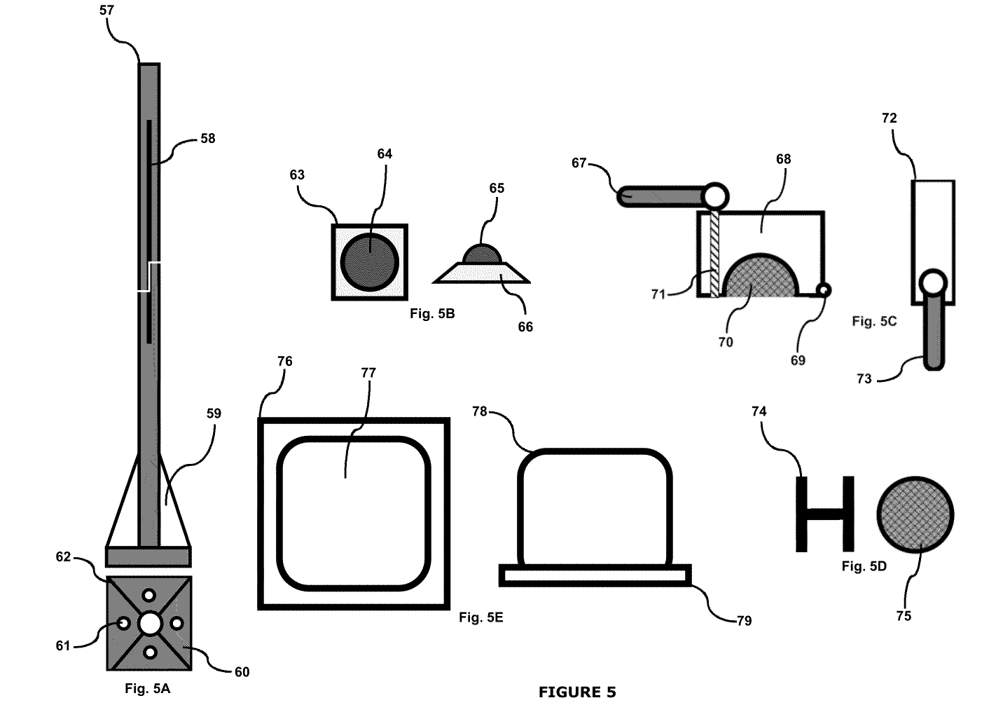

Turning now to FIG. 5, FIG. 5A, shows 57, shows the side view of the piston shaft assembly; 58, shows the side view of the limiter slot; 59, shows the triangular shaft reinforcements' gussets'; 60, Depicts the top view the shaft assembly; illustrating the relationship of the reinforcement gussets to the center part of the shaft, as well the bolt holes required for assembly attachment; and 61, shows the top view of the bolt holes. 62, the top plan view of the base plate assembly component of the vertical shaft rod; looking at FIG. 5B, 63, illustrates the top view of the ballast one-way valves 64, shows the top view of valve cap; 65, shows the side view of the valve cap, high output, generator; 66, depicts the side view of the valve assembly; Viewing now FIG. 5C, 67, shows the side view of the connection dog handle; 68, shows the side view of the dog block; 69, shows the side view of the assembly hinge; 70, illustrates the side view of the circular connection plate; 71, depicts the side view of the dog tightening bolt; 72, shows the top view of the dog assembly; 73, the top view of the dog handle; Turning to FIG. 5D, 74, end view of the dual connection plate; 75, the end view of the dual connection plate; Moving onto FIG. 5E, 76, is the top view of the control unit watertight assembly; 77, is the top view of the watertight cover; 78, is the side view of the watertight cover; and, 79, is the side view of the base plate of the watertight assembly.;

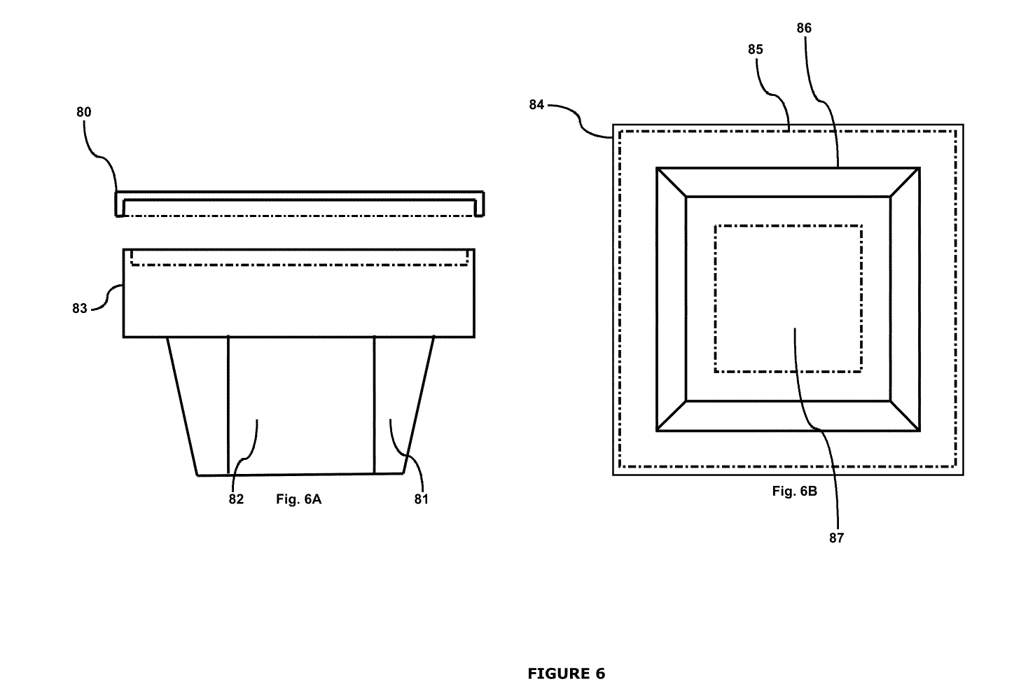

Referencing FIG. 6, shows the overall system components utilized as the standard base unit component in the invention. FIG. 6A, 80, is the side view of the watertight cover; 81, is the side view of the piston raceway; 82, is the side view of the ballast compartment which can be utilized for solids or liquid types of ballast; 83, is the side view of the base unit; FIG. 6B, 84, is the top view of the base unit; and, 85, is the top view of the watertight seal component; 86, is a top view of the molded base unit vertical wall; 87, depicts the top view of the ballast section bottom molded unit.

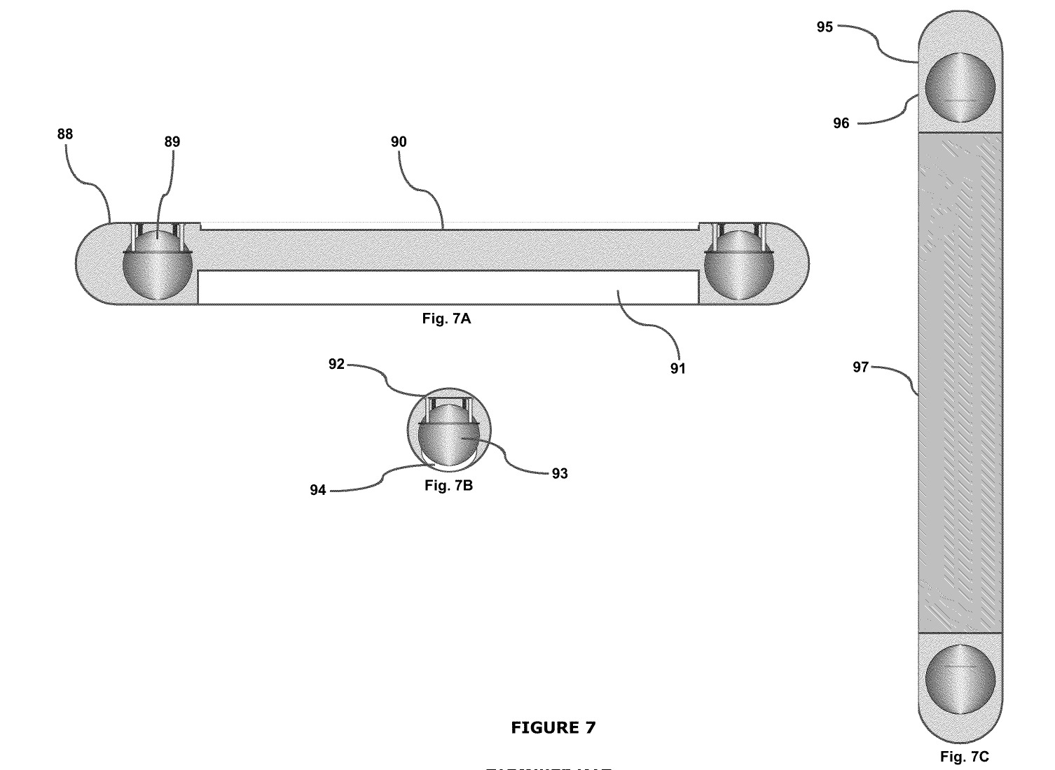

Turning now to FIG. 7, FIG. 7A, 88, is the side view of the ancillary pontoon submersible component; 89, shows one of the dual compressed air tanks mounted inside the pontoon; 90, shows the side view of the recessed unit mounting section; and 91, depicts the side view of the internal ballast tank for seawater ballast. FIG. 7B, 92, shows the end view of the ancillary pontoon submersible component; 93, depicts the end view of one of the dual the compressed air tank; 94, depicts a partial end view of the seawater ballast tank. FIG. 7C 95, shows the top view of the ancillary pontoon submersible component; 96, shows the top view of the one of the dual compressed air tanks; and 97, illustrates the top view of the base unit mounting section on the pontoon submersible component.

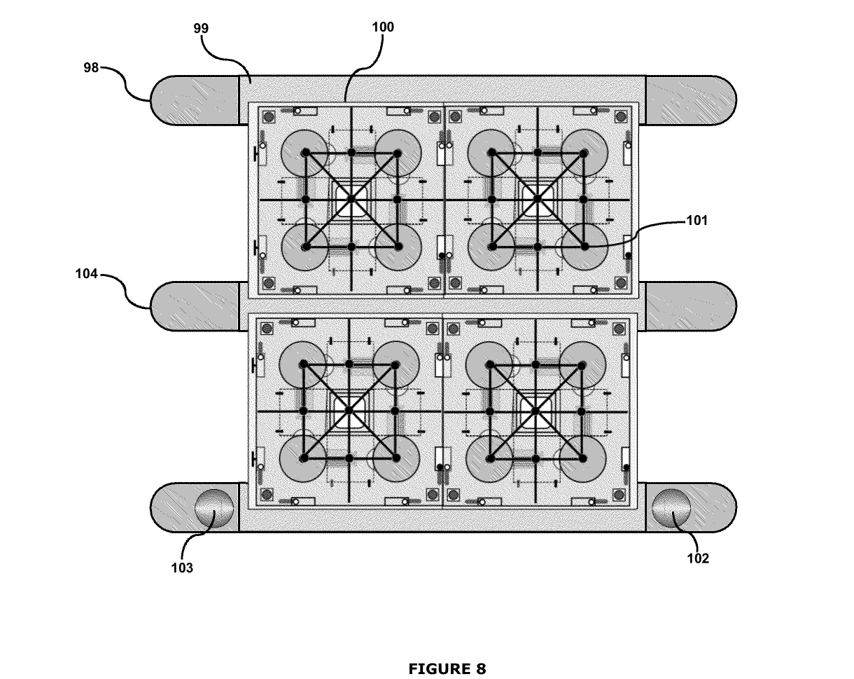

Now turning to FIG. 8, 98, shows the top view of the invention depicting a 1000 kWh unit utilizing the ancillary pontoon submersible components; 99, depicts the top view of the mounting surface which affords space for adjustments between base units; 100, illustrated the top view of the generating units; and, 101, shows the top view of the horizontal and vertical piston support mechanism. 102 and 103, depicts the standard positions of the compressed air tanks in all pontoon components; 104, shows the top view of the center pontoon component.

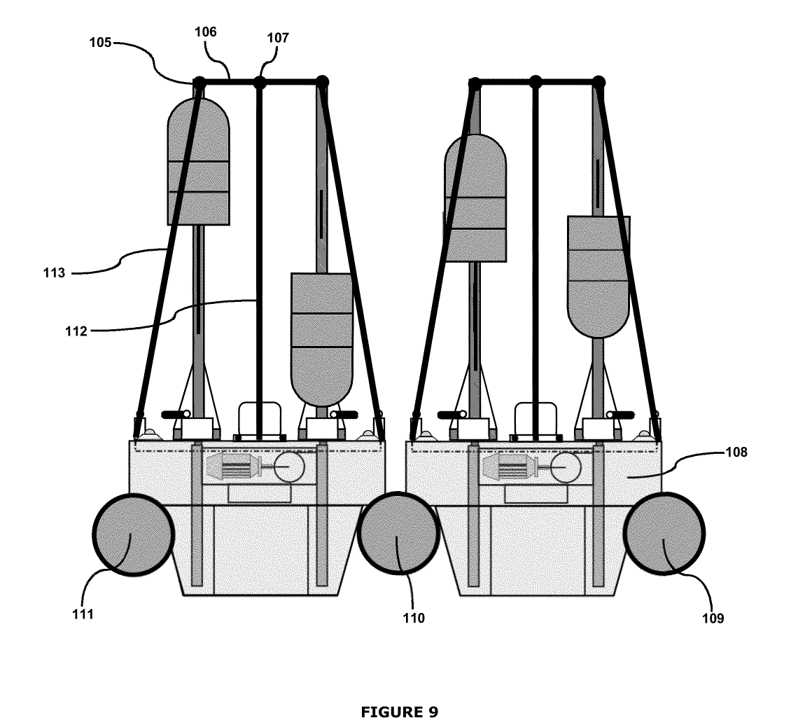

Now turning to FIG. 9, end view of two units with the horizontal and vertical piston support mechanisms are depicted. 105, is an end view of a corner circular connection hub; 106, shows the side view of the cross member; 107, shows the intermediary connection hub; 108, depicts an the end view of the base units connected; 109, illustrates the end view of the starboard pontoon submersible; 110, shows end view of the center pontoon submersible; 111, depicts the end view of the port pontoon submersible; 112, shows the end view of the diagonal upright member; while 113, shows the side view of the diagonal upright member.

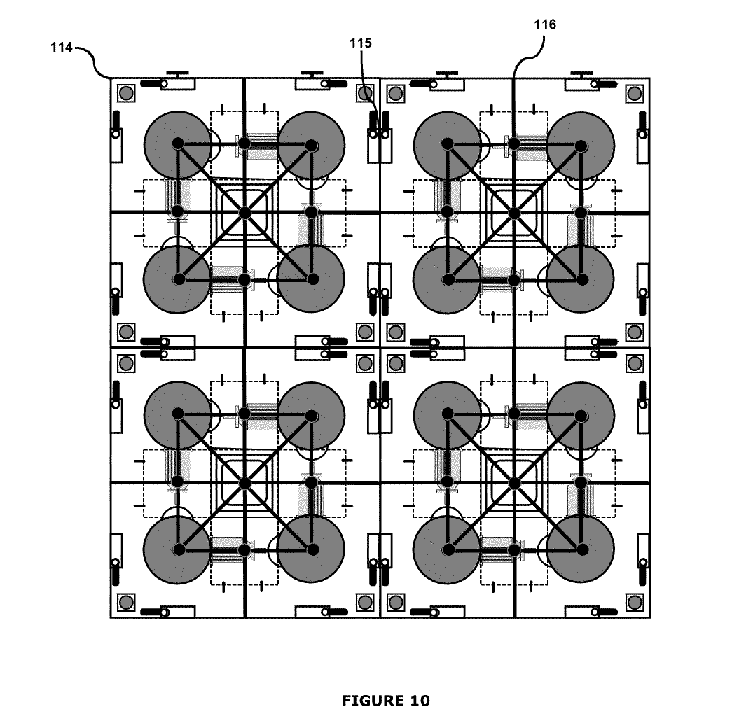

Referencing FIG. 10, the invention configured without the ancillary submersible pontoons. 114, illustrates the top view of a four component 1000 kWh unit; 115, shows the connections points between the components; while, 116, shows the top view of the horizontal and vertical piston support components in place;

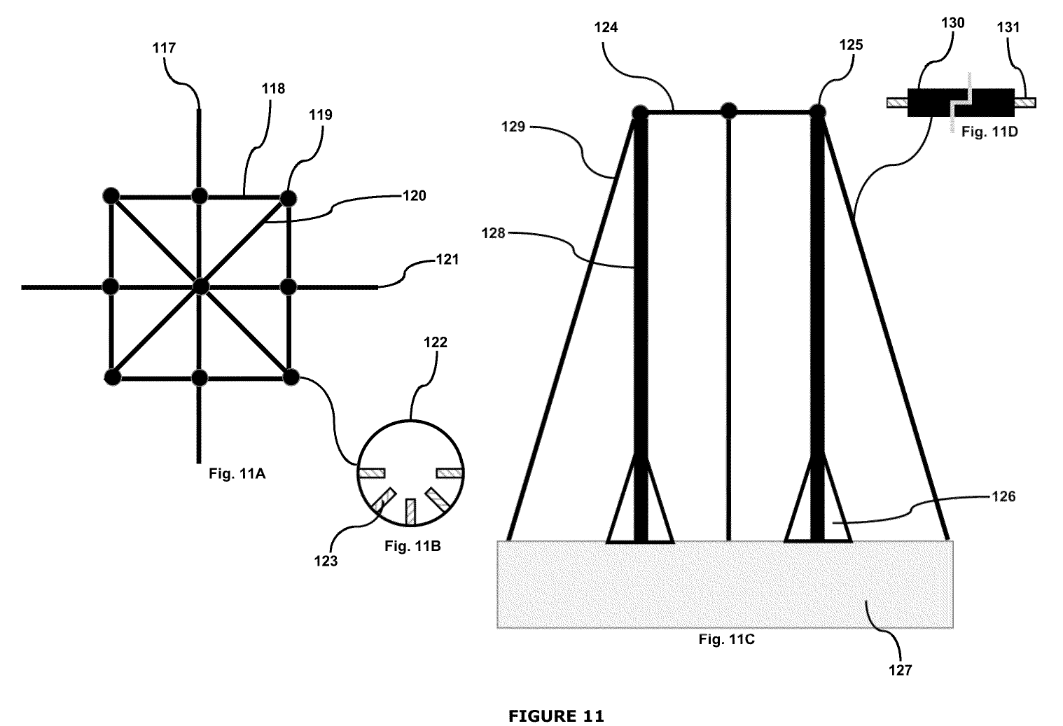

Now turning to FIG. 11, illustrates the inventions horizontal and vertical piston support components through FIG. 11A. 117, depicts the top view of the outer diagonal upright member; 118, illustrates the top view of the cross member; 119, shows the top view of the corner connector; 120, shows the top view of the diagonal cross member. 121, the top view of the number two outer diagonal upright member; Looking at FIG. 11B, 122, the side view of the number two corner connector drilled out at various angles to accommodate cross, horizontal, vertical and diagonal members; 123, is the side view of a typical drill hole. Referencing FIG. 11C, 124, the side view of the cross member; 125, is the side view of the corner connector; 126, illustrates the side view of the triangular support gussets; 127, shows the side view of the base unit 128, depicts the side view of the piston shaft assembly; while 129, shows the vertical shock assembly. Looking now to FIG. 110, 130, illustrates the typical horizontal, vertical, cross and diagonal members; while 131, depicts the side view of the screw portion of the shaft members.

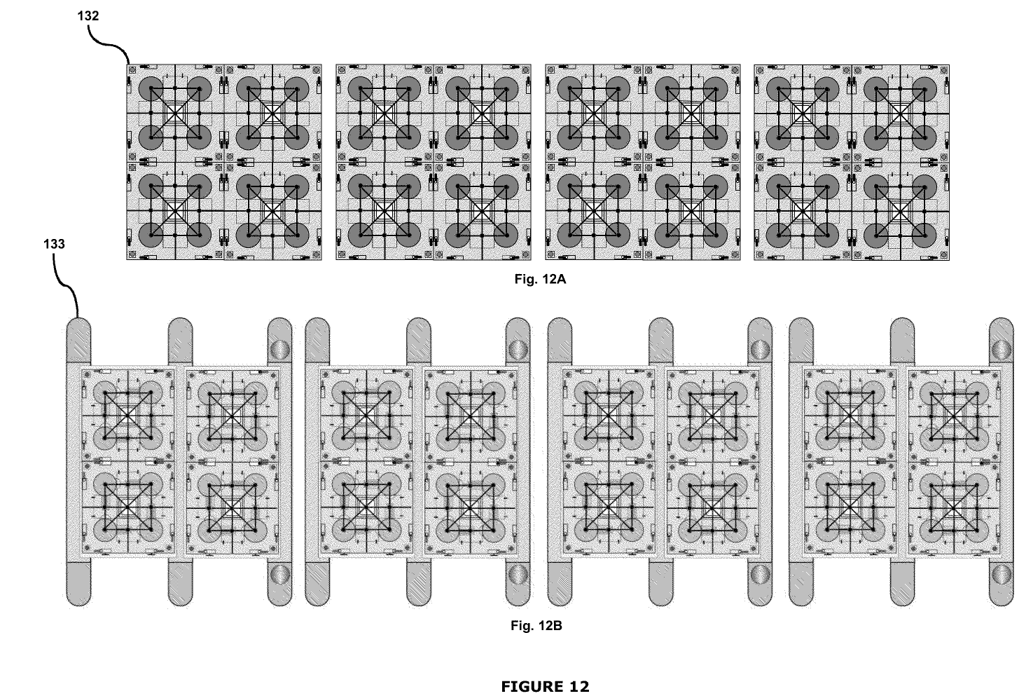

Now turning to FIG. 12, illustrates both configurations of the units; FIG. 12A, 132, shows the top view of a 4 MW unit configuration without the use of the submersible pontoons; while, FIG. 12B, 133, illustrates the top view of a 4 MW units utilizing the ancillary submersible pontoons.

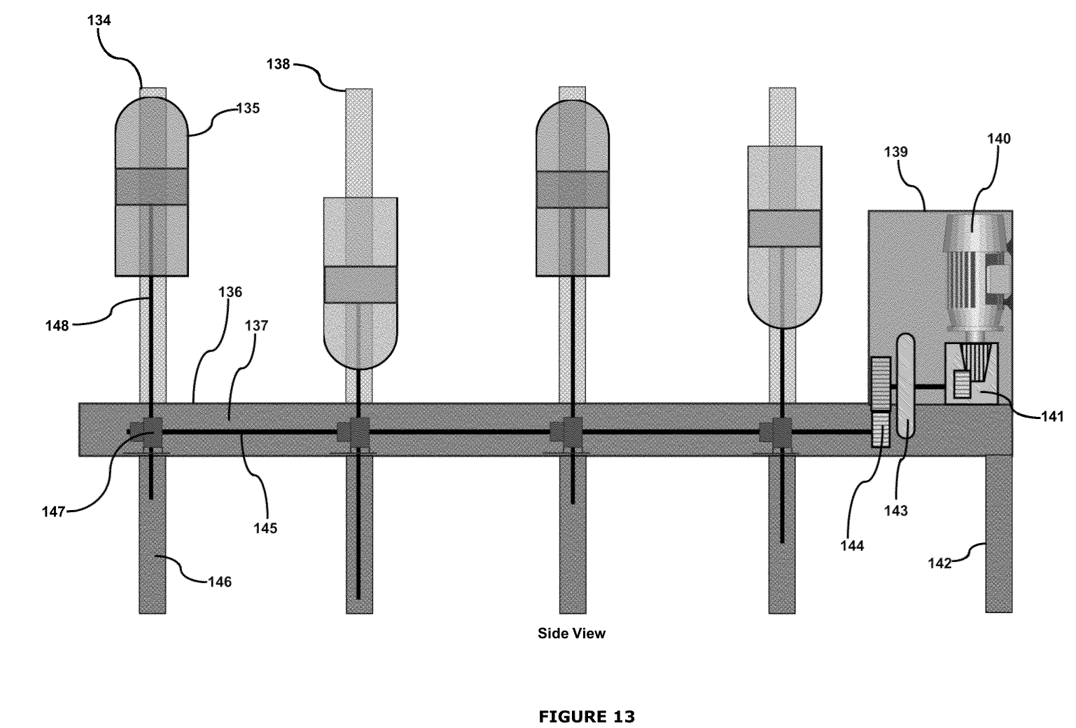

Further to FIG. 13, 134. depicts the side view of the piston shaft assembly; 135, shows the side view of the membrane piston going vertical; 136, illustrates the side view of the base unit. 137, is the side view of the environmental coating; 138, is the side view of the membrane piston in the down stroke position; 139, depicts end view of the generator watertight housing; 140, illustrates the vertical configuration of the generators; 141, depicts the ninety degree gear assembly; 142, illustrates the side view of the generator support leg; 143, shows the end view of the centrifugal fly wheel plate; 144, depicts the side view of the gear assembly; 145, is the side view of the drive shaft component 146, is the side view of the piston shaft raceway. 147, is the side view of the piston to shaft gear assembly; while, 148, is the side view of the piston rod shaft.

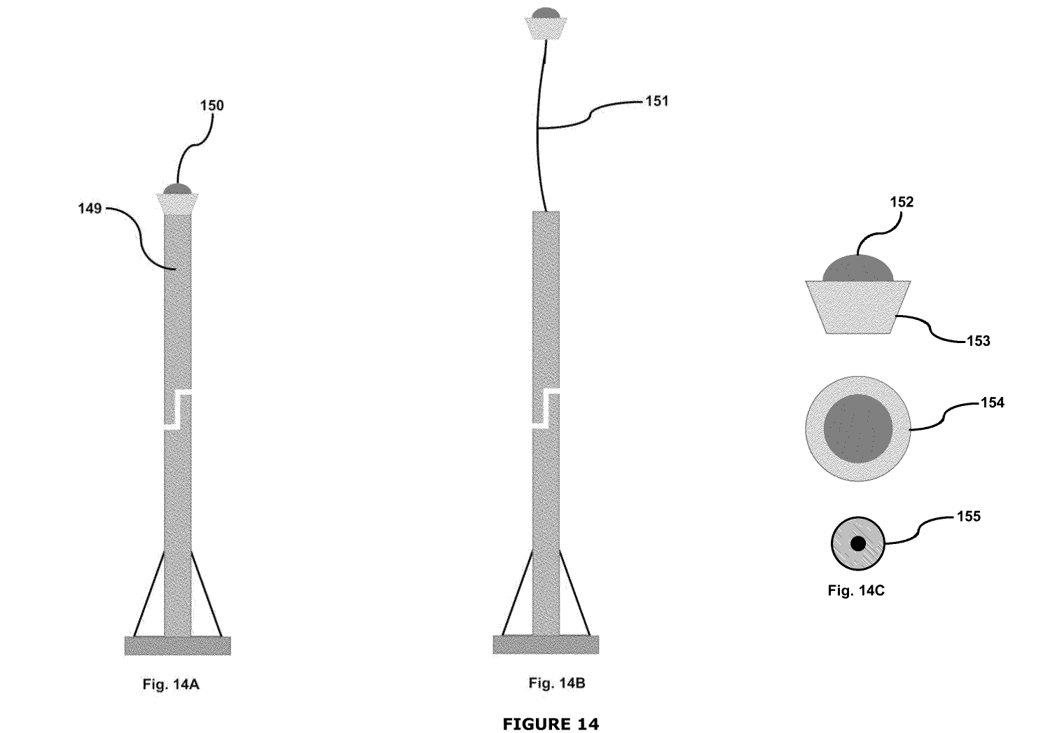

Turning to FIG. 14, illustrates the invention in the ‘lighted’ format. The components are completely compatible throughout the series of applications. Looking at FIG. 14A, 149, is the side view of the piston shaft assembly; 150, is the side view of the watertight lighting component; In FIG. 14B, 151, depicts the cable allowing for limited deployment towards the surface; While in FIG. 14C, 152, shows the side view of the lighted watertight lens assembly; 153, is the side view of the buoyant pot section of the assembly; 154, is the top view of the lighted watertight assembly; 155, is the bottom view of the lighted watertight assembly.

What is claimed is:

1. A system capable of generating electricity utilizing the kinetic energy produced by a moving wave comprised of;
a. An external wave component; and,
b. A series of actuating pistons that are compatible and sensitive to changes in the weight or pressure of the waves weight; and,
c. A series of generators consisting of but not limited to twenty 80 kW generators. These generators will be initiated by the movement of the pistons and will harness the unused kinetic energy produced by that movement; and,
d. A ceramic capacitor and or a dry cell battery storage unit for the holding of said electricity until compulsory; and,
e. A concrete or composite platform to hold power generating station or mechanism to attach generators directly to the sea shore; and,
f. A series of units capable of generating in unison power from the constant movement of the waves; and,
g. A series of electro-hydraulic pumps; and,
h. A extremely high strength base unit that is environmentally sound; and,
i. A sensor and control units relative and inherent to the generators, inclusive of other sensors, capable to withstand the underwater environment; and,
j. A panel for each system with sensors and communications capabilities.

2. The system and methods of claim 1, and further comprising that the system can work on all types of underwater environments including but not limited to, oceans and some lakes.

3. The system and methods of claim 2, further comprising that said power generating system will harness and collect energy. System will then store electricity until needed by and transferred ashore into the public grid.

4. The system and methods of claim 3, further comprising that the system will not compromise the environment.

5. The system and methods of claim 4, further comprising that the system can be used regardless of wave height and frequency where high output is not a consideration.

6. The system and methods of claim 5, further comprising that the Waves to Watts power generating system is highly adaptable to every type of geographic and weather environment.

7. The system and methods of claim 6, further comprising that the Waves to Watts power generating system is highly adaptable and can be formatted to any future technologies.

8. The system and methods of claim 7, further that the number of units deployed will correspond to the required number of kWm or MW proposed for the area in which the units are deployed.

9. The system and methods of claim 8, further that near future development if Piston types will be considered as inherent to the invention.

10. The system and methods of claim 9, further offers that the invention has many manifestations as to specific applications in terms of types of an underwater environments; and, that all components are inter-changeable and compatible throughout the entire system,
